(19) United States
(12) Patent Application Publication
(10) Pub. No.: US 2010/0308190 A1
(43) Pub. Date: Dec. 9, 2010

(54) DEVICE FOR RELEASABLE MOUNTING OF CABINETS OR THE LIKE TO FLOORS IN GALLEYS IN AIRPLANES

(76) Inventor: Maurice Tkocz, Huettenberg (DE)

Correspondence Address: KF ROSS PC, 5683 RIVERDALE AVENUE, SUITE 203 BOX 900, BRONX, NY, 10471-0900, US

(21) Appl. No.: 12/745,359

(22) PCT Filed: Mar. 16, 2009
(86) PCT No.: PCT/EP09/01908

§ 371 Date: Jun. 11, 2010

(30) Foreign Application Priority Data
Mar. 18, 2008 (DE) 20 2008 0003 772.

(51) Int. Cl. F16M 13/02

(52) U.S. Cl. 248/222.14

(57) ABSTRACT

The invention relates to a device for releasable mounting of cabinets or similar installed equipment in galleys (2) of airplanes on seating rails (6) placed in the direction of flight on the cabin floor. Rearrangement is to be made possible with significantly reduced time, in a simple manner, in order to provide space for further rows of seats, and wherein large forces in various directions are to be absorbed. To this end, a quick-mounting means (1) receiving and supporting a kitchen unit (2; 5) comprises as components, successively from top to bottom, a clamp lever (7), a base (3; 103) and a slot nut (13) engaging in a raster groove (15) of the seat rail (6), wherein said components are preassembled on a threaded bolt means (18; 18a, 18b) provided centrally in flush holes (16), being held together loosely in the untensioned state of the quick-mounting means by an integrated spring (14), allowing motion of at least the slot nut (13).

The invention relates to a device for releasable floor mounting of cabinets or similar built-in equipment to the floor of an aircraft galley on seat rails extending in the flight direction on the cabin floor.

Independent of the type of aircraft, a galley having several pieces of built-in equipment elements is installed near a door on floor rails extending either in the flight direction or transverse to the flight direction. Moreover, the galleys or its parts are mounted to the aircraft via the ceiling. Depending on load and forces within the galley, each of the floor mounts has to absorb forces in the X- and Y- as well as the Z-direction.

The mount known from previous practice uses screw connections installed with a predetermined torque. The mounting screws are primarily loaded by longitudinal forces, i.e. in the vertical Z-direction. To absorb forces acting in flight or the X-direction, and in the transverse or Z-direction, additional measures must be taken. These typical floor mounts using screw connections require considerable installation work and also special tools if seating capacity in the aircraft is to be varied. In fact, in this case, the entire galley has to be moved.

Thus, the object of the invention is to provide a mount of the above-mentioned type that allows a rearrangement of galleys in aircrafts in a simple manner and with significantly reduced time in order to provide space for further rows of seats, and that, at the same time, meets the high safety standards and absorbs the large forces occurring in the different directions.

This object is attained according to the invention in that a quick-release mount receiving and supporting a kitchen unit comprises as parts, successively from top to bottom, a latch lever, a base, and a T-nut engaging in a T-groove of the seat rail, the parts being carried on a threaded bolt assembly provided centrally in aligned bores, being held together loosely in an untensioned state of the quick-release mount by an integrated spring, and allowing clearance for movement of at least the T-nut. Despite the clearance for movement, a quick-release mount can be achieved which is completely preassembled, interconnected and ready for use. After insertion into the T-groove, which allows a gradual adjustment or displacement, the latch lever has to be pivoted against the force of the spring to securely fix the quick-release mount on the seat rail.

According to one proposal of the invention, a galley or built-in piece of equipment is carried by an array of at least four quick-release mounts. This results in a load distribution over a plurality of mounting points, for example on all walls of the galley or its assembled elements. By pivoting the latch lever into the locking position and by the resulting closure of all parts, all degrees of freedom of the loosely preassembled quick-release mount are locked.

If retrofitting is required, this is to be carried out without tools in the shortest possible time. It is only necessary to pivot the latch levers in the opposite direction, i.e. into their open position. The form- and force-fitting connection achieved with the quick-release mount according to the invention is thus released, and the kitchen or individual cabinets or the like, which are built on top of or next to each other, and which are supported by the plurality of quick-release mount, can be moved by means of the quick-release mount which slide with their T-nuts in the seat rails into the desired position. The moving properties of the quick-release mount can be enhanced if the sections of the quick-release mount that slide in the seat rails and/or the seat rail are provided with a coating which facilitates the sliding, for example Teflon.

According to a preferred embodiment of the invention the spring is a compression spring bearing against the T-nut and surrounded by a locking block fitted into the base and that is surrounds a stem of the T-nut. With the latch lever open, the spring, which is completely encapsulated against the outside, pushes the locking block upward, the locking block lifting away from the T-nut and releasing it in such a manner that subsequent displacement of the complete floor mount is possible.

If, according to another advantageous proposal, the locking block has at least two sides facing the longitudinal edges of the T-groove of the guide rail and formed according to the invention as spanner flats, and preferably the locking block as a whole is square, then the locking block, which absorbs in particular the forces in the X- and Y-direction, is also suited to prevent the T-nut from jamming during the movement. It also contributes to prevent jamming of the T-nut if the base of the quick-release mount is equipped on its bottom face with guide ribs that engage in the T-groove of the guide rail.

According to a proposal of the invention, an inner and an outer eccentric bushing are concentrically arranged above the locking block in the through hole of the base. By adjusting the eccentric bushings it is possible to compensate for aircraft-related tolerances during assembly and to perform a fine adjustment.

If, preferably, the latch lever is arranged on a pressure piece, this contributes substantially to the absorption of the load transmitted to the latch lever.

One embodiment of the invention provides that the base is formed in two pieces and consists of a bottom piece and a top piece. According to another embodiment having a one-piece base, the latch lever with the pressure piece is arranged in an aperture of an upper part on the lower aperture bar. A quick-release mount having a one-piece base and an upper part arranged thereon can be designed narrower and higher because, for example, a further eccentric, if required, can be provided in the upper part to compensate for tolerances in the Z-direction.

The threaded bolt assembly that passes through the aligned bores of all the necessary parts to hold the parts together can be configured as a stud of the T-nut onto which a nut can be screwed from the latch lever side. An alternative proposal provides that the threaded bolt assembly is a screw that bears downward with its head within the latch lever and that can be screwed at its other end into the T-nut.

Further features and details of the invention are disclosed in the claims and the following description of embodiments of the invention illustrated in the drawings. Therein:

FIG. 1 is a front detail view of a quick-release mount fixed on an aircraft seat rail, which quick-release mount supports an illustrated galley part;

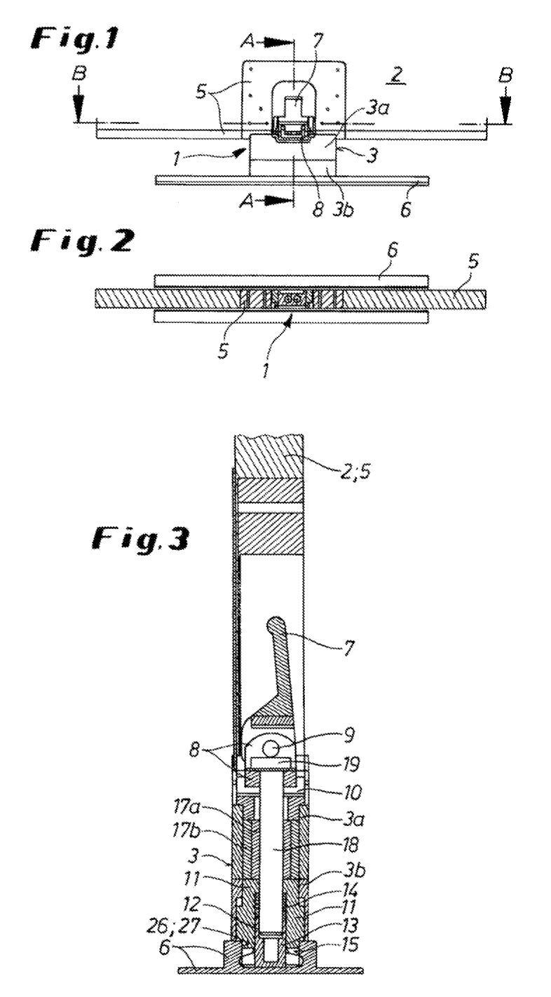

FIG. 2 is a section through the quick-release mount taken along line B-B of FIG. 1;

FIG. 3 is a large-scale section of the quick-release mount of FIG. 1 taken along line A-A;

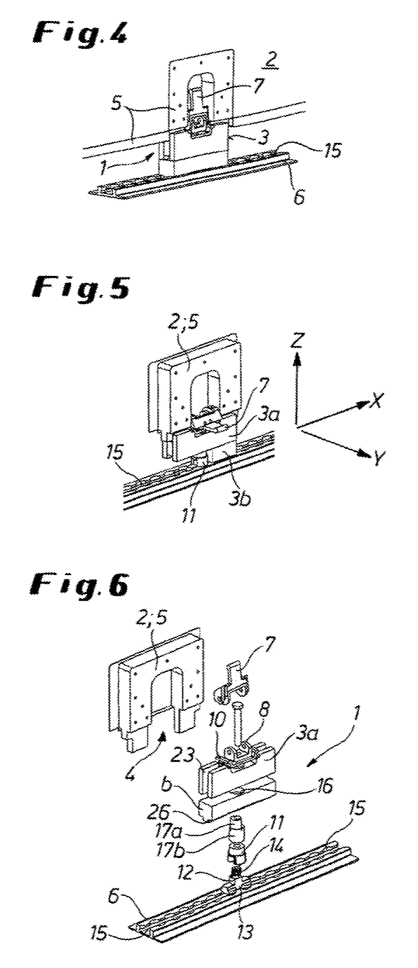

FIG. 4 is a perspective view of the structure of FIG. 1;

FIG. 5 is another perspective sectional view of the left lower side of the rail of the structure of FIG. 4 but with the quick-release mount's latch lever open for displacement;

FIG. 6 is a perspective exploded view of the quick-release mount of FIG. 1;

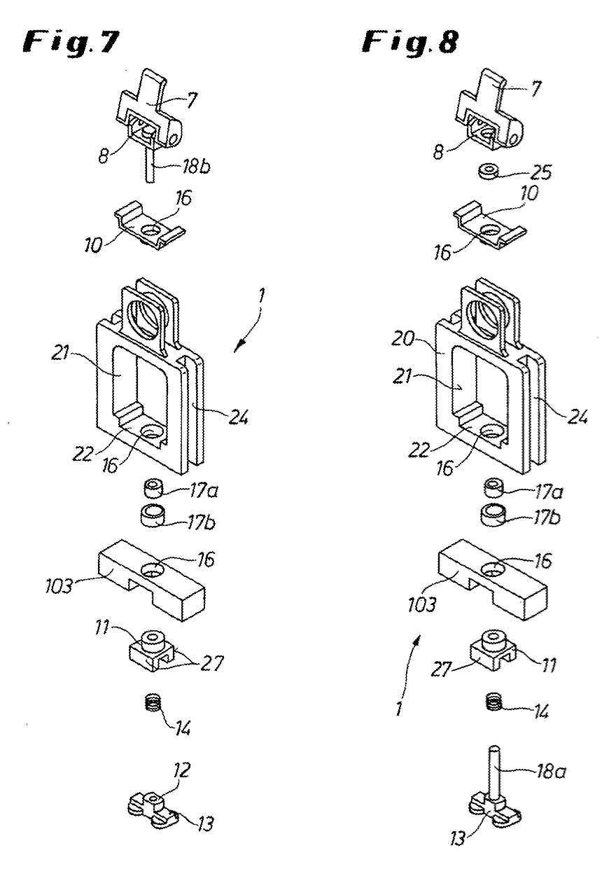

FIG. 7 is a perspective exploded view of another embodiment of a quick-release mount; and

FIG. 8 is a view like FIG. 7 but with a different arrangement of the threaded bolt assembly for holding the individual parts together.

FIGS. 1 to 6 show a quick-release mount 1 that supports a galley or a galley unit 2 composed of a plurality of cabinets or the like, for which reason a plurality of the quick-release mount 1 are arranged in an array. Of the galley unit, only a wall 5 having a cutout 4 (see FIG. 6) is shown, which wall is fitted onto a base 3 of the quick-release mount 1. The galley unit 2 is fixed on parallel seat rails 6 by means of the quick-release mount 1. The quick-release mount 1 as connector to the wall can extend longitudinally or transversely of the seat rail 6. In the locking position, a latch lever 7 of the quick-release mount 1 takes a position in which it is pivoted up, thereby engaging in a cutout of the wall 5. In contrast, FIG. 5 shows the latch lever's 7 unlocked pivot position projecting out from the wall 5 of the galley 2.

As shown in detail in FIGS. 3 and 6, from top to bottom, i.e. toward the seat rail 6, the latch assembly is formed by a plurality of parts. The latch lever 7 is pivotal about a pivot pin 9 in a U-shaped profile 8 and bears on the base 3 via a pressure piece 10. The base 3 is of two pieces and consists of a top piece 3a and a bottom piece 3b. A locking block 11 in the base or bottom piece 3b fits with a stem 12 of a T-nut 13 and holds a spring 14, here a compression spring 14, braced against the stem 12.

The T-nut 13 fits in a T-groove 15 of the seat rail 6 (see FIG. 6), which T-groove is formed to allow incremental adjustment. Above the locking block 11, an inner and an outer eccentric bushing 17a and 17b are arranged in a through-hole 16 of the base 3 or top piece 3b. All the above-mentioned parts are held together by a threaded bolt assembly 18 that passes through bores of all parts, which bores are aligned with the through-hole 16 of the base 3 so that the threaded bolt assembly rests with its screw head 19 on the U-shaped profile member 8 of the latch lever 7 and is screwed with its lower end into the T-nut 13.

The variant of the quick-release mount 1 shown in FIGS. 7 and 8 differs from the above-described embodiment substantially only in that only a flat and narrower base 103 and a higher extending upper part 20 arranged thereabove is provided. The upper part has an aperture 21 against whose lower aperture bar 22 the pressure piece 10 with latch lever 7 and the U-shaped profile member 8 bears. While in the embodiment according to FIGS. 1 to 6, the top piece 3a is provided with end grooves 23 for interfitting with the wall 5 of the galley 2, here the upper part 20 has two such end grooves 24. In contrast to FIG. 7 in which, as in the embodiment according to FIGS. 1 to 6, the threaded bolt assembly is configured as a screw 18b which can be screwed into the T-nut 13, the threaded bolt assembly, according to FIG. 8, is an integrated stud bolt 18a of the T-nut 13, onto which a nut 25 is screwed from above in the U-shaped profile member 8.

By providing the bottom piece 3b of the base 3 (see FIG. 6) with narrow downwardly projecting guide ribs 26 or by forming the locking block 11 with flat faces 27 that extend at least along the edges of and into the T-groove 15 of the seat rail 6, jamming of the mounting means 1 during displacement in the T-grooves 15 is prevented.

In any case, the parts of quick-release mount 1 that are loosely held together by the compression spring 14 make easy displacement possible, whereas by pivoting the latch lever 7 into the locking position (see FIGS. 1 and 3), effects locking onto the seat rail 6 to meet all requirements of the flight operation.

### REFERENCE NUMBER LIST

1 Quick-release mount
2Galley/kitchen unit
3, 103 Base
3a Top piece
3bBottom piece
4 Cutout
5 Wall
6 Seat rail
7 Latch lever
8 U-shaped profile member
9 Pivot pin
10 Pressure piece
11 Locking block
12 Stem
13 T-nut
14 Spring/compression spring
15 T-groove
16 Through-hole
17a Inner eccentric bushing
17b Outer eccentric bushing
18 Threaded bolt assembly
18a Stud bolt
18b Screw
19 Screw head
20 Upper parts
21 Aperture
22 Aperture bar
23 End-face groove
24 Receiving groove
25 Nut
26 Guiding rib
27 Spanner flat

1. A mount for releasably securing a cabinet or similar piece of built-in equipment to the floor of an aircraft galley on seat rails extending in the flight direction on the cabin floor, wherein a quick-release mount receiving and supporting a kitchen unit comprises as parts, successively from top to bottom, a latch lever, a base, and a T-nut engaging in a T-groove of the seat rail, the parts being carried on a threaded bolt assembly provided centrally in aligned holes and being held together loosely in the untensioned state of the quick-release mount by an integrated spring allowing motion of at least the T-nut.

2. The mount according to claim 1, wherein the spring is a compression spring bearing against the T-nut and surrounded by a locking block fitted into the base and surrounding a stem of the T-nut.

3. The mount according to claim 2, wherein an inner and an outer eccentric bushing are concentrically arranged above the locking block in the through-hole of the base.

4. The mount according to claim 1 wherein the locking block has at least two sides facing longitudinal edges of the T-groove of the guide rail are formed as guide flats.

5. The mount according to claim 1 wherein the latch lever is carried on a pressure piece.

6. The mount according to claim 1 wherein the base is formed with downwardly projecting ribs that engage in the T-groove of the guide rail.

7. The mount according to claim 1 wherein the base is a two-piece part and consists of a bottom piece and a top piece.

8. The mount according to claim 1 wherein in a one-piece base, the latch lever with the pressure piece is arranged in an aperture of the upper part on a lower aperture bar.

9. The mount according to claim 1 wherein the threaded bolt assembly is formed as a stud of the T-nut onto which a nut can be screwed from the latch lever side.

10. The mount according to claim 1 wherein the threaded bolt assembly is a screw that bears its head within the latch lever and that can be screwed with its other end into the T-nut.

11. The mount according to claim 1 wherein a galley or a galley built-in unit is arranged on an array of at least four such quick-release mounts.

12. In combination with an aircraft-floor rail formed with an upwardly open T-slot and with a piece of galley equipment, a mount comprising:
a base fixable on the piece of equipment and formed with an upwardly directed bearing surface and a throughgoing bore opening at the surface;
a T-nut fittable in and slidable along the T-groove and lockingly upwardly engageable with the rail;
a threaded bolt projecting upward from the T-nut through the bore;
a latch lever engageable downwardly with the surface and movable between a locked position pulling the T-nut up into tight engagement with the rail and an unlocked position with the T-nut slidable along the T-groove; and
a spring bearing on the base and operatively engaging the T-nut and so as to urge the T-nut downward.

13. The combination defined in claim 12 wherein the spring is a compression spring bearing upward directly against the base and downward directly against the T-nut.

14. The combination defined in claim 12 wherein the base is formed with a transversely throughgoing notch and the T-nut fits in the locked position complementarily in the notch, whereby the T-nut cannot pivot in the T-slot.

15. The combination defined in claim 12 wherein the latch lever is pivotal about a longitudinal axis on an upper end of the bolt and has an eccentric formation bearing downward on the base.

16. The combination defined in claim 12 wherein the base is formed of a single piece formed with a central transversely throughgoing aperture in which the levers is fitted and into which an upper end of the bolt projects.

17. The combination defined in claim 12 wherein the base is formed with downwardly projecting longitudinal ribs flanking the bolt and slidable along the T-groove.

18. The combination defined in claim 12 wherein the bolt has a lower end threaded into the T-nut and an upper end provided with a head and connected to the latch lever.

19. The combination defined in claim 12 wherein the bolt is formed unitarily with the T-nut as an upwardly projecting stud having an upper end provided with a nut connected to the latch lever.

20. The combination defined in claim 12 wherein the T-nut has a pair of arms extending longitudinally of the rail.
